(19) United States
(12) Patent Application Publication
(10) Pub. No.: US 2012/0116906 A1
(43) Pub. Date: May 10, 2012

(54) CREDIT CARD READER FOLIO AND BILLING SYSTEM FOR WAIT STAFF

(75) Inventor: Rene R. Lundy, Bend, OR (US)

(73) Assignee: BELLATRIX SYSTEMS, INC., BEND, OR (US)

(21) Appl. No.: 13/103,964

(22) Filed: May 9, 2011

Related U.S. Application Data
(60) Provisional application No. 61/332,645, filed on May 7, 2010.

(51) Int. Cl. G06Q 30/06; G06K 7/01

(52) U.S. Cl. 705/26.1; 235/380

(57) ABSTRACT

According to the present invention, restaurant folios, for example, are equipped with a credit card reader, the card reader having memory and a communication port. The customers swipe their credit cards, for example, at the table and the credit card information is stored in the card reader. Waiters retrieve the card reader/folios combinations and carry them to an existing remote billing location. At the billing location a docking system receives local, preferably wireless, communication from the card readers and transfers card information to an establishment's existing centralized point-of-sale (POS) system as though the card had been taken from the customer at the table and swiped at the remote billing location.

This application claims priority from U.S. provisional patent application No. 61/332,645, filed May 7, 2010, and incorporates this prior application by reference.

### BACKGROUND OF THE INVENTION

1. Field of the Invention

This invention relates generally to retail transactions in restaurants and bars and other food and drink service areas. More specifically, this invention relates to a portable check folder (folio) for wait staff including a credit card reader, memory and a communication port. The folio conveniently communicates via a docking system with the establishment's existing billing system.

2. Related Art

Currently, the general practice of wait staff at food and drink establishments is to obtain the patron's cash or credit card at the table when it is time to pay the bill. Then, the wait person proceeds to a remote billing station, and, for credit cards, enters the patron's card information and the amount of the bill at a point-of-sale (POS) terminal or register. Many patrons are uncomfortable with this process because their credit card is taken temporarily out of their possession.

One approach to eliminate the need for separating the credit card from the patron has been to provide a local, wired or wireless billing station at each table. These table systems may also include ordering capability, as well as other communication capabilities, with the wait staff, or even directly to the kitchen. However, these table systems require additional displays, keyboards, logics, printers and communications equipment for each table or for each wait person. Also, these table systems typically require that the restaurant or bar proprietor acquire and install new, and often expensive and complex, billing and accounting programs.

For example, U.S. Pat. No. 5,933,812 (Meyer et al.) discloses a portable transaction terminal system with a hinged folio cover, a data entry keypad and alphanumeric display on the folio's top face, a card reader and a computer system including data communication means for sending transaction data to an external terminal system.

US Published Patent Application #US2002/0069165 (O'Neil) discloses a mobile terminal system for customers to pay with short range wireless technology from their table.

Also, US Published Patent Application #US2005/0071232 (Frater) discloses a customer register at the table which communicates wirelessly with a restaurant/bar main register to allow payment by the customer at the table. The main register is further connected to an external network.

Also, U.S. Pat. No. 6,973,437 (Olewicz et al.) discloses a wirelessly connected customer register at the table.

In addition, these systems with table displays, keyboards and printers are complicated for patrons to learn. Finally, they often also require a patron to enter a tip in front of the waiter or verbally tell the waiter how much tip is to be applied to the bill. This tip process is not well received in some markets, as it may be embarrassing for the patrons.

US Published Patent Application #2006/0064373 (Kelley) discloses a remote payment terminal with a keyboard, display and printer.

Also, U.S. Pat. No. 7,457,767 (Dunsmore, et al.) discloses a remote payment terminal with a keyboard, display and printer.

Also, US Published Patent Application #US2009/0037286 (Foster) discloses a remote payment terminal with a keyboard, display and printer.

In addition, previous approaches to signaling wait staff when a patron is ready to pay typically rely on a device added to the table or to the folio. Typically, these devices contain a mechanical or electronic actuator which requires the patron to remove the check or press a button to activate the indicator.

For example, U.S. Pat. No. 5,355,115 (Goon et al.) discloses a wait staff signaling device which includes a light or a flag which may be manually activated for communicating to a wait staff person.

### SUMMARY OF THE INVENTION

According to the present invention, restaurant folios are equipped with a credit card reader, memory and a communication port. The customers swipe their credit cards at the table and the credit card information is stored in the folio. A waiter retrieves the folio and carries it to the existing remote billing location. At the billing location a dock receives local communication from the folio and transfers credit card information to the centralized point-of-sale (POS) system as though the card had been swiped at the remote billing location.

The current invention overcomes the challenges of prior art discussed above in several ways. One, the current invention is far less expensive as it only provides a credit card reader and, optionally, a simple lighted display for each waiting bill. Two, the normal process where the wait staff recovers the bill from the table, prints out a receipt at a central location, and returns the bill to the table for signature and tip is retained. This maintains the preferred tip process for the customer and reduces costs by maintaining the effectiveness and efficiency of an already existing centralized POS system.

The current invention also improves upon the prior art by checking for some basic information like expiration date and card number set format, ensuring a preliminary level of validity of the card at the table in the card reader itself, without need for connection to a central system. Further and final validation of the card is then performed by docking the credit card reader to an inexpensive common interface that is attached to the existing POS without need for changes to the POS. These improvements reduce cost and complexity.

For example, the folio system of the present invention overcomes the problem requirement of existing pay-at-table systems because the additional cost and bother of training for both wait staff and customers of newly installed hardware/software is avoided. Also, the folio system of the present invention avoids the need for installation of a completely new and expensive accounting system that works around the existing POS system. Instead, the folio system of the present invention offers a common, universal interface (USB or similar) that is compatible with virtually all existing POS systems without modification.

Furthermore, the current invention overcomes the prior art signaling limitations by providing an integrated approach. According to an optional embodiment of the invention, a credit card reader is connected to circuitry that, when a valid credit card is read, automatically activates an indicator such as an LED to attract the wait staffs attention.

In the case of split bills, multiple swipes from different cards may be made into the folio.

Optionally, all the credit card data may be encrypted for security purposes.

Optionally, a light on the folio illuminates after the credit card has been swiped, indicating to the wait staff that the folio is ready to be picked up. Also, optionally, the docking station may have a digital display indicating the type of card that has been swiped at the table. This way, for example, those establishments which do not honor a particular type of card may screen out these types of cards promptly after their being swiped.

Optionally, multiple folios may be stacked in a vertical or horizontal slotted charging stand at or near the remote billing location, for example, to (re)charge them, and ready them for use the following cycle, shift, or day.

### BRIEF DESCRIPTION OF THE DRAWINGS

FIG. 1 is a top, side perspective view of a wait staff folio opened up to receive one reader embodiment of the present invention shown in close proximity to the folio.

FIG. 2 is a top, side perspective view of the card reader/folio combination depicted in FIG. 1, but opened up to show the credit card reader attached to the folio.

FIG. 3 is a bottom perspective view of the embodiment depicted in FIG. 2, but with the folio being closed.

FIG. 4 is a top, side perspective view of a docking station receiver device that accepts credit card information via either infrared, radio or other wireless communication from the card reader/folio combination embodiment depicted in FIGS. 1-3, and transfers, via the USB port cord depicted in the Figure, the card information to an existing point-of-sale (POS) device that normally accepts a swipe reader.

FIG. 5 is a side perspective view of the folio embodiment depicted in FIGS. 2 and 3 being in close proximity to a single charging station device.

FIG. 6 is a side perspective view of the folio embodiment depicted in FIGS. 2 and 3 being in close proximity to a multiple set of vertically arranged charging stations.

FIG. 7 is a top, side perspective exploded view of one of the vertically arranged charging stations and the folio embodiment depicted in FIG. 6.

### DETAILED DESCRIPTION OF PREFERRED EMBODIMENTS OF THE INVENTION

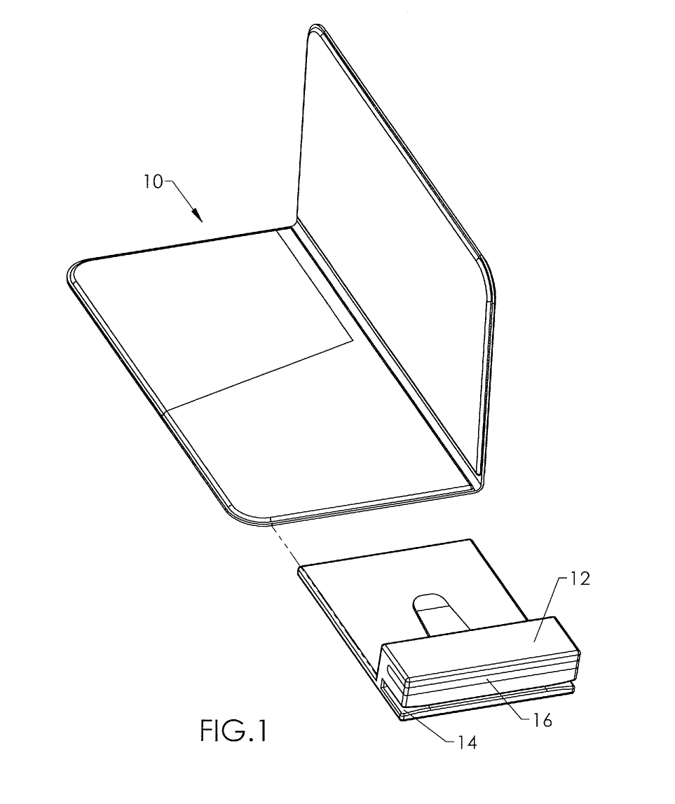

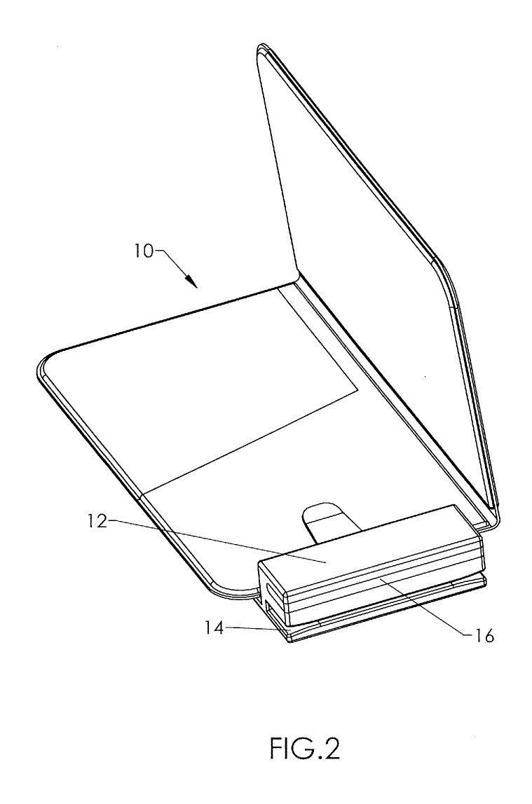

Referring to the figures, there is shown one, but not the only, embodiment of the present invention. FIGS. 1 and 2 depict one embodiment of the folio and card reader combination 10 of the present invention. Credit card reader 12 clips to an edge of folio 10. Reader 12 is of conventional construction to the extent that it can access and read credit card information on a card that is swiped through its slot 14. In an alternate embodiment, card reader 12 may be manufactured integrally with the folio. In another alternate embodiment, card reader 12 may be made available to the wait staff in or with another format besides a folio, such as a mini-PDA, which PDA contains reader 12 for being left at the table for the wait staff when the food or beverage service is completed.

Reader 12 may be used with credit cards, debit cards, rebate cards, etc. Also, reader 12 may be clipped directly to the bill or to the menu, or to a table top “specials” display stand, and not to a folio.

In addition, reader 12 has a battery and power system (not shown) and an antenna 16, which is a communication port for wirelessly communicating, preferably via infrared, the swiped credit card information to a receiver docking station (not shown in these two Figures). Also, reader 12 has some digital memory for storing data and instructions regarding proper credit card format, including, for example, card type and number set format. Reader 12 may have an indicator, such as a flashing light (not shown in these two Figures), to automatically signal the wait staff that a card has been swiped. Furthermore, reader 12 may have a calendar for checking credit card expiration date. However, the features of reader 12 are intentionally limited to avoid added complexity and cost. Therefore, reader 12's memory requirements are modest, generally less than about 1 megabyte.

Reader 12's antenna 16 may be of conventional design for wireless transmission via infrared (ir) of the card, billing and meal information data. Preferably, the ir transmission is short range, i.e. under about 12 inches, from the reader to the docking station receiver 20. In an alternate embodiment, reader 12 may have a contact terminal (not shown) for wired transfer of the information when receiver 20 is integral with charging station(s) 30 and 30′ according to description later in this document.

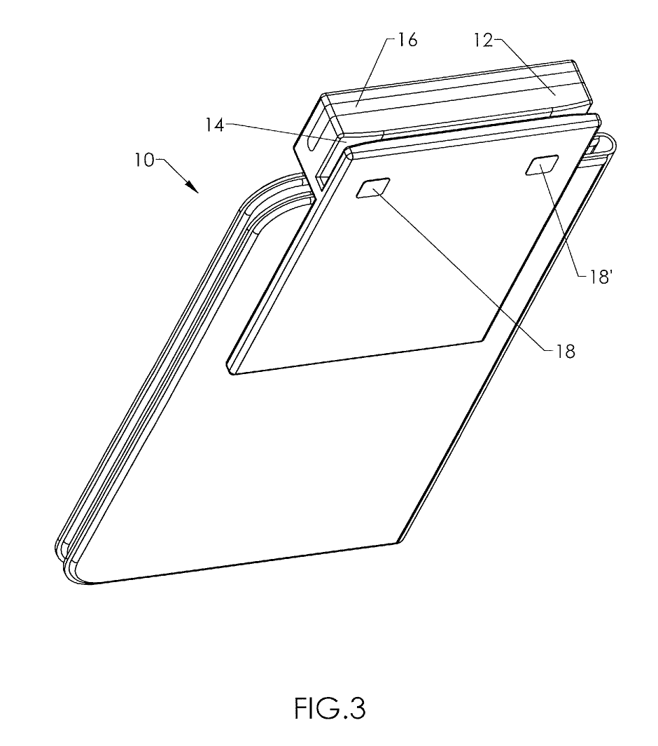

FIG. 3 depicts the card reader/folio combination depicted in FIGS. 1 and 2, but shows also on the bottom of the reader a set of recharging terminals 18 and 18′ which are adapted to contact cooperating terminals on a charging station (not shown in this Figure) for (re)charging the power supply of reader 12.

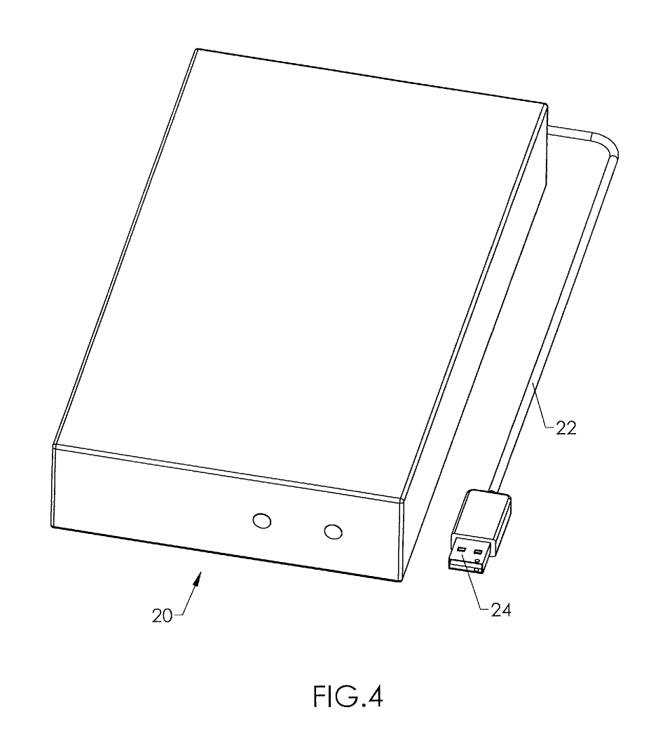

FIG. 4 depicts docking station receiver 20 which wirelessly accepts credit card information from card reader/folio combination 10's card reader 12 through antenna 16. Receiver 20 accepts card information via either infrared, radio or other wireless communication. Then, receiver 20 transfers this information via cord 22 and USB port 24 in conventional manner to an existing POS device in a remote billing location of the eating and/or drinking establishment. The standard USB interface is conveniently, economically and widely available and accepted by most POS software/hardware combinations. Alternatively, receiver 20 may be adapted to transfer reader 12's card, billing and meal information, etc. directly to the establishment's central billing system.

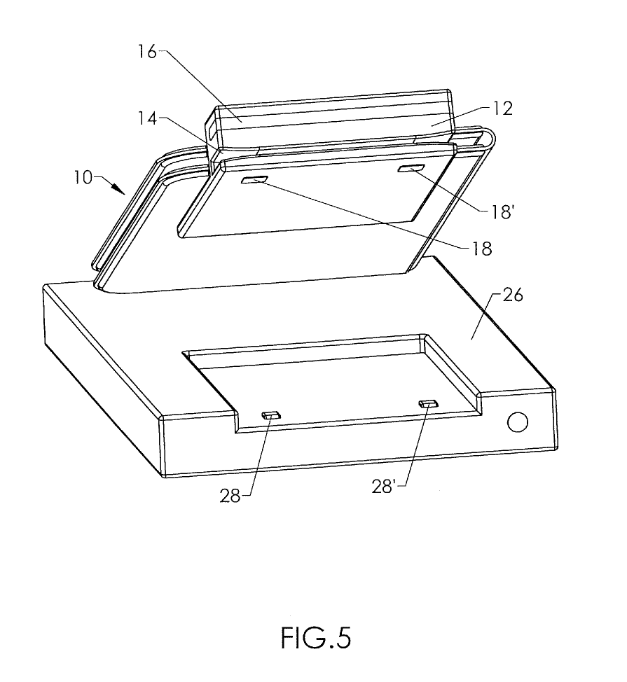

FIG. 5 depicts card reader/folio combination 10 in close proximity to a single charging station 26. Charging station 26 has contact terminals 28 and 28′ adapted for cooperating with charging terminals 18 and 18′, respectively, on the bottom of card reader 12 for (re)charging the battery of the power system of reader 12. Alternatively, reader 12 may be detached from the folio and charged separately, thus allowing for a smaller and less expensive charging system.

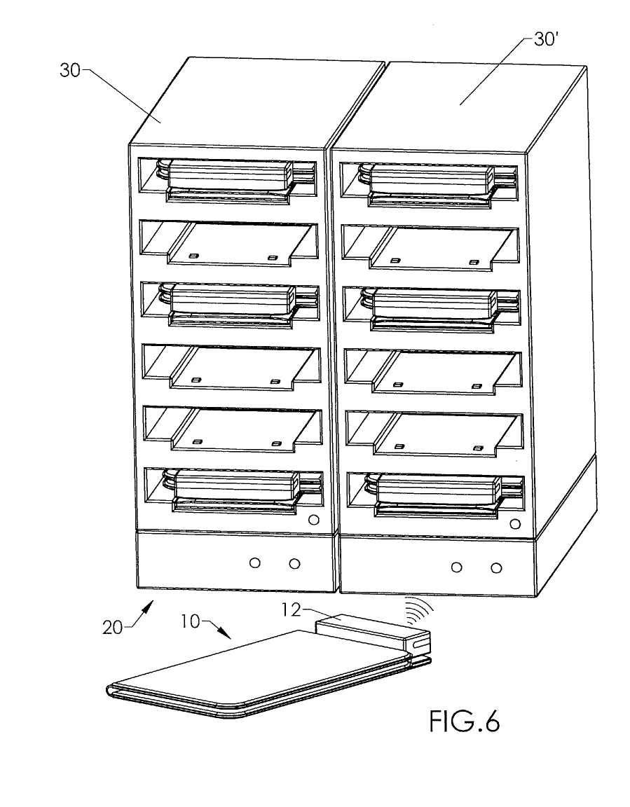

FIG. 6 depicts a card reader/folio combination 10 in close proximity to, and other folios parked within, a multiple set of vertically arranged charging stations 30 and 30′. The charging stations may also be arranged horizontally. The charging stations 30 and 30′ (re)charge the batteries in card reader 12, and provide a convenient place to store reader 12 between cycles, shifts or days. Alternatively, the charging station(s) may be adapted to contain docking station receiver 20, and automatically transfer the card reader/folio combination's information when they are placed in the station. In this alternative embodiment, the information transfer may be wired, for example, also through contact terminals 28 and 28′, or through a different contact terminal (not shown in these Figures).

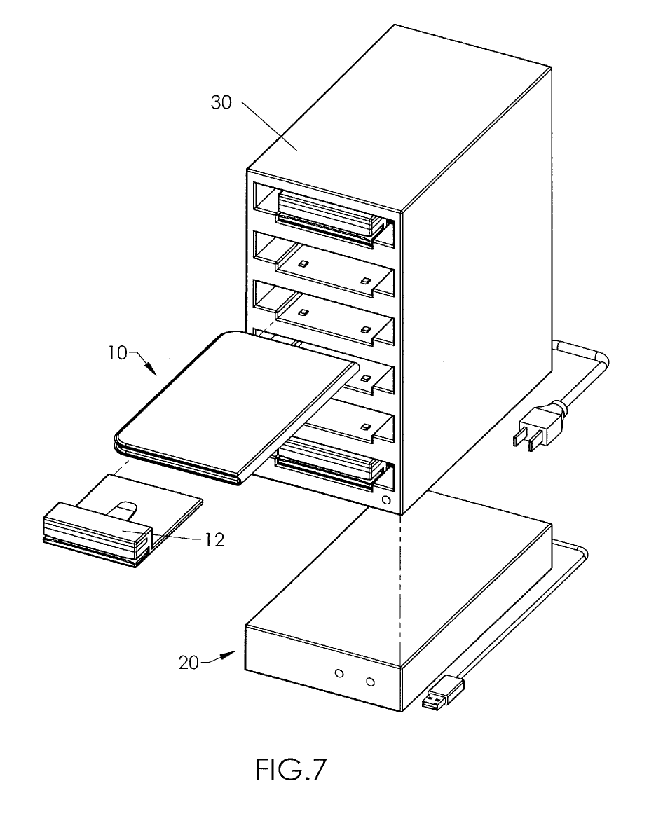

FIG. 7 depicts an exploded view of one of the vertically arranged charging stations and card reader/folio combination depicted in FIG. 6.

Also, optionally, the docking station receiver 20 may have a digital display (not shown in this Figure) indicating the type of card and/or name of the card holder that was swiped at the table. This way, for example, multiple cards may be accessed and sent to the POS device for a “split check” billing, and/or those establishments which do not honor a particular type of card may promptly screen them out.

Although this invention has been described above with reference to particular means, components and embodiments, it is to be understood that the invention is not limited to these disclosed particulars, but extends instead to all equivalents within the scope of the following claims.

I claim:

1. A card reader/wait staff folio combination for a billing system in an establishment, the establishment having an existing billing system which accepts cards for payment, comprising:
a portable check folder or folio, and a card reader, the card reader being connectable to the folio and having memory and a communication port;
the card reader being adapted to communicate with a docking system comprising a receiver, remote from the portable card reader/folio combination, via the card reader's communication port; and,
the docking system also comprising a USB or similar interface which transfers information from the docking system receiver to the establishment's existing billing system.

2. The card reader/folio combination of claim 1 wherein the card reader is separable from, but connects to, the folio.

3. The card reader/folio combination of claim 1 wherein the card reader is integral with the folio.

4. The card reader/folio combination of claim 1 wherein the card reader communicates with the docking system receiver wirelessly via infrared.

5. The card reader/folio combination of claim 1 wherein the docking system provides a space for (re)charging and storing the card reader/folio combination.

6. The card reader/folio combination of claim 5 wherein the docking system space for (re)charging and storing the card reader/folio combination is separate from the docking system receiver.

7. The card reader/folio combination of claim 5 wherein the docking system space for (re)charging and storing the card reader/folio combination is integral with the docking system receiver.

8. A card reader for a billing system in an establishment, the establishment having an existing billing system which accepts cards for payment, comprising:
a portable card reader, the card reader having memory and a communication port;
the card reader being adapted to communicate with a docking system comprising a receiver, remote from the card reader, via the card reader's communication port; and
the docking system also comprising a USB or similar interface which transfers information from the docking system receiver to the establishment's existing billing system.

9. The card reader of claim 8 wherein the card reader communicates with the docking system receiver wirelessly via infrared.

10. The card reader of claim 8 wherein the docking system provides a space for (re)charging and storing the card reader.

11. The card reader of claim 10 wherein the docking system space for (re)charging and storing the card reader is separable from the docking system receiver.

12. The card reader of claim 10 wherein the docking system space for (re)charging and storing the card reader is integral with the docking system receiver.

13. A method for collecting payment in an establishment which accepts cards for payment, the establishment having an existing billing system, comprising:
presenting to the customer a bill for goods and services with a portable card reader, the card reader having memory and a communication port;
communicating with the card reader via its communication port by a docking system, the docking system comprising a docking system receiver, which receiver is remote for the card reader; and,
transferring the card reader's information communicated to the docking system receiver from the receiver to the establishment's existing billing system.
